(19) United States
(12) Patent Application Publication
(10) Pub. No.: US 2007/0204277 A1
(43) Pub. Date: Aug. 30, 2007

(54) Computer program and method for managing implementation of a process

(76) Inventors: Andrew L. Burgess JR., Desert Hills, AZ (US); David A. Sullivan, Chandler, AZ (US); Jerrald D. Naumann, Phoenix, AZ (US)

Correspondence Address: Meschkow & Gresham, P.L.C., Suite 409, 5727 N. 7th Street, Phoenix, AZ, 85014, US

(21) Appl. No.: 11/364,386

(22) Filed: Feb. 27, 2006

(51) Int. Cl. G06F 9/46

(52) U.S. Cl. 719/318

(57) ABSTRACT

A method (54) utilizing a computing system (30) for managing implementation of a process (34) enables selection of a procedure (58) that includes hierarchically ordered events (68), each representing a portion of the process (34). Each event (68) has a set (76) of associated event outcomes (62), each being linked to another event (68) within the procedure (58). The method (54) obtains at least one event object (60) associated with a first event (68) and instantiates the event object (60) to present the first event (68) and the set (76) of event outcomes (62) to a user (24). A user input (138) is received at the computing system (30) that includes one of the event outcomes (62) indicating completion of the first event (68). The method (54) proceeds to another event (68) within the procedure (58) to implement the process (34) in response to the one event outcome (62).

### TECHNICAL FIELD OF THE INVENTION

The present invention relates to the field of process management. More specifically, the present invention relates to the computerized management of a hierarchy of tasks in a process.

### BACKGROUND OF THE INVENTION

A process is a collection of related tasks that produce something of value to an organization, its stake holders, or its customers. A process controls which task of a network of tasks will be performed by whom and which resources are exploited for each task. Thus, a process describes how an organization realizes its services to its customers.

The management of tasks in a process can involve significant human collaborative activity. By way of example, the processing and tracking of a legal case may entail the coordination and scheduling of lawyers, judges, administrative personnel, and many others. In addition, processing a legal case may further entail the transmission, gathering, and assimilation of large quantities of documents and other information from a variety of sources. Once gathered, this information may be used to resolve the case.

Conventional management schemes for processing and tracking a legal case are often prone to errors due to the imposition of manual entry in a client's file every time a document is sent or other noteworthy event takes place. Moreover, these schemes do not prompt the legal representative or support staff to assure the timely advancement of the case from one stage to the next. The untimely advancement of a case through various information gathering and evaluation stages often results in a more expensive and protracted resolution of the case. Also, conventional schemes often make it difficult to quickly access the status of a given client's case in response to a phone call or other request requiring a quick turn around.

Frequently, poor coordination, scheduling, and information management leads to cases that are not resolved properly, promptly, or fairly. In addition, information collection and case management tasks often limit the quantity of cases that can be handled concurrently by a given number of legal support personnel. Consequently, case processing and tracking can be expensive, complex, prone to error, and relatively unreliable in maintaining the collected information.

Attempts have been made to manage the implementation of mechanistic processes through the use of software tools. The objective of these software tools is to document or model a process, automatically execute a process, and track an instance of a process so that information on its state can be easily seen. Unfortunately, execution of a process is typically achieved by using a patchwork of interfacing software (transferring the data from one application to another) and human intervention (for example, reading the data printed out from one application and entering it into another). Due to the complexity that this approach engenders, modifying a process is costly and an overview of the processes and their status is difficult to obtain.

Human-driven processes focused on human collaborative activity, such as a legal case, can be particularly problematic due to the need for complex and timely interaction between the various human workers necessary to carry out the various tasks. In carrying out processes that entail significant human participation, it is critical that each participant understands his or her responsibilities for carrying out the process, that goals/endpoints for each process task are understandable, and that the status of a process can be readily obtained by authorized participants.

Consequently, what is needed is a system that can promote orderly and controlled passage of tasks (both mechanistic and human-driven) within a process, achievement of process management goals/endpoints, and effective use and allocation of resources. Moreover, what is needed is a software tool that allows for the execution of a process and/or modification of a process without costly and time intensive development of software.

### SUMMARY OF THE INVENTION

Accordingly, it is an advantage of the present invention that a computer-based method and a computer program are provided for managing implementation of a process.

It is another advantage of the present invention that a computer-based method and a computer program are provided that promote an orderly and controlled passage of tasks within a process.

Another advantage of the present invention is that a computer-based method and a computer program are provided that streamline a process and allow for effective utilization of resources.

Yet another advantage of the present invention is that a computer-based method and a computer program are provided that that are cost effectively implemented.

The above and other advantages of the present invention are carried out in one form by a method utilizing a computing system for managing implementation of a process. The method calls for enabling selection of a procedure from a data storage element of the computing system. The procedure includes hierarchically ordered events, each of the events representing a portion of the process. Each event has a set of event outcomes associated therewith, each of the event outcomes of the set being linked to another of the events within the procedure. The method further calls for obtaining, from the data storage element, an event object associated with a first one of the events and instantiating the event object to present the first event and the set of event outcomes associated with the first event to a user. A user input is received at the computing system that includes one of the event outcomes from the set of event outcomes, the one event outcome indicating a completion of the first event. The method proceeds to another of the events within the procedure to implement the process in response to the one event outcome.

The above and other advantages of the present invention are carried out in another form by a computer-readable storage medium for managing implementation of a process. The computer-readable storage medium includes a data storage element having a procedure and a plurality of event objects stored therein, the procedure including hierarchically ordered events, and each of the events representing a portion of the process. Each event has a set of event outcomes associated therewith, each of the event outcomes of the set being linked to another of the events within the procedure. The computer-readable storage medium further includes executable code for instructing a processor to perform operations comprising enabling selection of the procedure from the data storage element, obtaining, from the data storage element, a first one of the plurality of event objects associated with a first one of the events, and instantiating the first event object to present the first event and the set of event outcomes associated with the first event to a user. The executable code instructs the processor to perform further operations comprising enabling the user to interact with the presented first event, receiving at the computing system following the enabling operation a user input that includes one of the event outcomes from the set of event outcomes, the one event outcome indicating a completion of the first event, and proceeding to another of the events within the procedure to implement the process in response to the one event outcome, the proceeding operation being prevented until the one event outcome is received.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a schematic layout diagram of a network of computing systems in which the present invention may be implemented;

FIG. 2 shows a block diagram of a computing system for executing a computer program, in the form of a process management system, for managing implementation of a process;

FIG. 3 shows a diagram of exemplary notation for procedure event;

FIG. 4 shows a diagram of exemplary notation for one of a number of procedures of the process management system;

FIG. 5 shows a flowchart of a process modeling component of the process management system;

FIG. 6 shows a flowchart of a process execution component the process management system;

FIG. 7 shows a flowchart of an event definition subprocess;

FIG. 8 shows a flowchart of an event outcome definition subprocess;

FIG. 9 shows a flowchart of a user input subprocess;

FIG. 10 shows a flowchart of a parameter management subprocess;

FIG. 11 shows a screen shot image of a first event data display for a first case presented in response to execution of the process execution component of the process management system;

FIG. 12 shows a screen shot image illustrating a second event data display for the first case;

FIG. 13 shows a screen shot image illustrating a third event data display for the first case; and

FIG. 14 shows a screen shot image illustrating a fourth event data display for the first case.

### DETAILED DESCRIPTION OF THE PREFERRED EMBODIMENTS

The present invention promotes orderly and controlled passage of tasks (both mechanistic and human-driven) within a process, achievement of process management goals/endpoints, and effective use and allocation of resources. Efficient management of processes and related personnel reduces the amount of man-hours expended during the execution of a process and enables an organization to manage implementation of more processes with less cost. In addition, the present invention provides a software tool that allows for the execution of a process and/or modification of a process without costly and time intensive development of software.

The present invention will be discussed in connection with managing processes associated with various judicial cases. More specifically, the present invention will be discussed in connection with managing cases that are processed under Canon Law. Canon Law is the body of laws and regulations made by or adopted by ecclesiastical authority, for the government of a Christian organization and its members. However, the present invention need not be limited to such a function. Rather, the concepts of the present invention may be readily adapted to the management of various processes including other judicial processes, marketing and billing processes, insurance processes, development or production processes, and so forth. The correct and efficient execution of such processes within an organization is of enormous importance and has significant influence on the organization's overall success.

The following is a glossary of terminology used herein:

Process: is a collection of related tasks that produce something of value to an organization, its stake holders, or its customers.

Procedure: is a set of computerized hierarchically ordered steps that enable a process to be implemented.

Procedure Event: is each step in a procedure.

Procedure Event Identifier: is a unique identifier given to each procedure event within a procedure.

Procedure Event Path: is a definition of the way in which a procedure is organized from beginning to conclusion.

Procedure Event Outcome: is provided within each procedure event and allows for the submission and notification that the procedure event is complete.

Procedure Event Thread: is one instance of a procedure event.

Procedure Event Object: is self-contained unit of code that can consist of both data and procedures that can be acted upon by a computer system to manipulate the data. A procedure event may contain one or more procedure event objects.

Process Instance: is one instance of a process. There can be multiple instances of a process running concurrently on the same computing system.

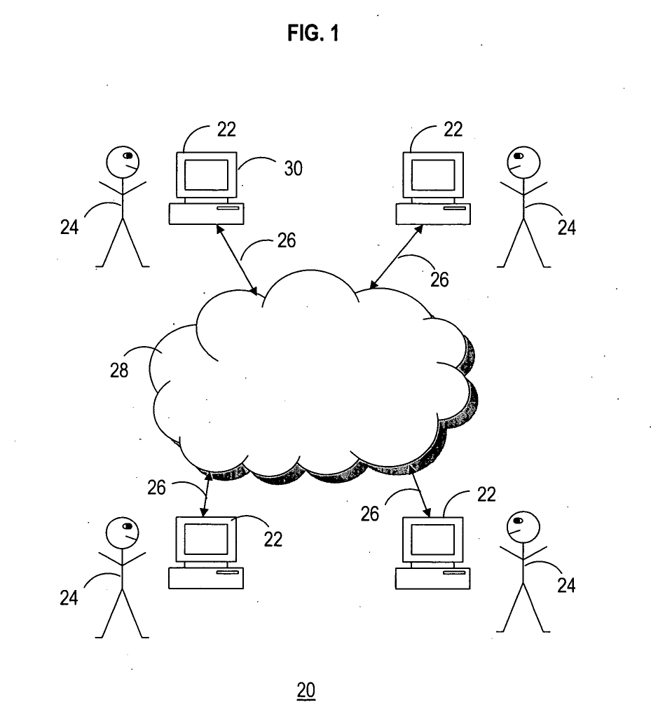

FIG. 1 shows a schematic layout diagram of a network 20 of computing systems 22 in which the present invention may be implemented. Each of computing systems 22 may be positioned at various locations within an organization, and each may be operated by a user 24. Network connections, represented by bidirectional arrows 26, interconnect each of computing systems 22 to a cloud element 28 representing network data paths, i.e., the interconnectivity of computing systems 22, through network 20.

For purposes of the present invention, a first one of computing systems 22, referred to hereinafter as computing system 30, serves as a central management system for managing the implementation of processes related to the organization. The remaining computing systems 22 may be selectively enabled to allow other users 24 within the organization to directly enter and check the status of the processes managed by computing system 30, to work remotely and fulfill their duties, to obtain the same documents and procedures, and so forth.

The present invention is advantageously operable within network 20. However, the present invention need not be limited to such a use. Rather, the present invention may be operable on computing system 30 without interconnection to network 20.

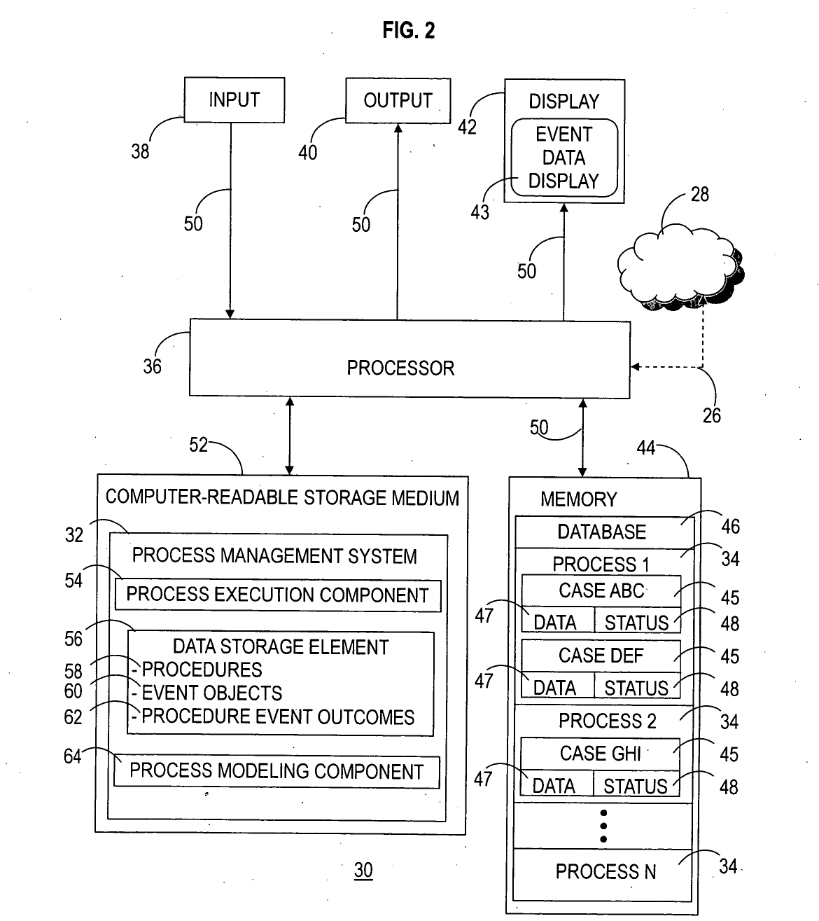

FIG. 2 shows a block diagram of computing system 30 for executing a computer program, in the form of a process management system 32, for managing implementation of processes 34. As mentioned above, the present invention will be discussed in connection with managing cases that are processed under Canon Law. Consequently, each of processes 34 is a judicial-process defined under Canon Law. Such judicial processes include, but are not limited to, Formal Annulment (includes. Documentary and Collegiate), Formal Appellate, Appellate by Ratification (Second Instance), Marriage Dispensation/Permission, Absence of Canonical Form, Pauline Privilege, Petrine Privilege, Frater-Soror, Sanatio, Presumed Death. Each of processes 34 is crafted to follow a specific sequence of steps, or events, as laid forth by Canon Law. For clarity of illustration, process 34 is a certain flow of events that are dependent upon the outcome of previous events. A “case” is one instance of an entire one of processes 34.

Computing system 30 includes a processor 36 on which the methods according to the invention can be practiced. Processor 36 is in communication with an input device 38, an output device 40, a display 42, and a memory system 44 for storing a database 46 of multiple instances of processes 34, i.e., cases 45, along with data 47 and status indicators 48 related to each of cases 45 currently being managed by computing system 30, and generated in response to the execution of process management system 32. These elements are interconnected by a bus structure 50.

Input device 38 can encompass a keyboard, mouse, pointing device, audio device (e.g., a microphone), and/or any other device providing input to processor 36. Output device 40 can encompass a printer, an audio device (e.g., a speaker), and/or other devices providing output from processor 36, and display 42 represents information in visual form, as an event data display 43. Computing system 30 can also include network connections, modems, or other devices used for communications with other computer systems or devices via network data paths 28.

Computing system 30 further includes a computer-readable storage medium 52. Computer-readable storage medium 52 may be a magnetic disk, compact disk, or any other volatile or non-volatile mass storage system readable by processor 36. Computer-readable storage medium 52 may also include cooperating or interconnected computer readable media, which exist exclusively on computing system 30 or are distributed among multiple interconnected computer systems (not shown) that may be local or remote.

Process management system 32 is recorded on computer-readable storage medium 52 for instructing processor 36 to manage cases 45, related data 47, and management status 48 which can be stored in database 46. Process management system 32 includes executable code in the form of a process execution component 54. Process management system 32 further includes a data storage element 56 for archival of procedures 58 (hierarchically ordered events that enable one of processes 34), event objects 60 (self-contained unit of code), procedure event outcomes 62 (element that allows for the submission and notification that an event within a procedure is complete). Data storage element 56 containing procedures 58, event objects 60, and procedure event outcomes 62 may be defined for an organization by an outside software designer and provided to that organization for its use. Through the execution of process management system 32, procedures 58, event objects 60, and procedure event outcomes 62 can be accessed from data storage element 56 in order to manage cases 45.

Data storage element 56 and database 46 is discussed herein as separate entities saved on different media. However, it should be readily apparent to those skilled in the art of database configuration will recognize that that data storage element 56 and database 46 can be stored on a common medium and can take on a great variety of forms.

Process management system 32 may optionally include a process modeling component 64 for instructing processor 36 to create procedures 58 for each of processes 34. That is, a knowledgeable user 24 (FIG. 1) may develop their own procedures 58 pertinent to their organization using provided event objects 60 and procedure event outcomes 62. Still other users may additionally generate their own customized event objects 60 and procedures event outcomes 62.

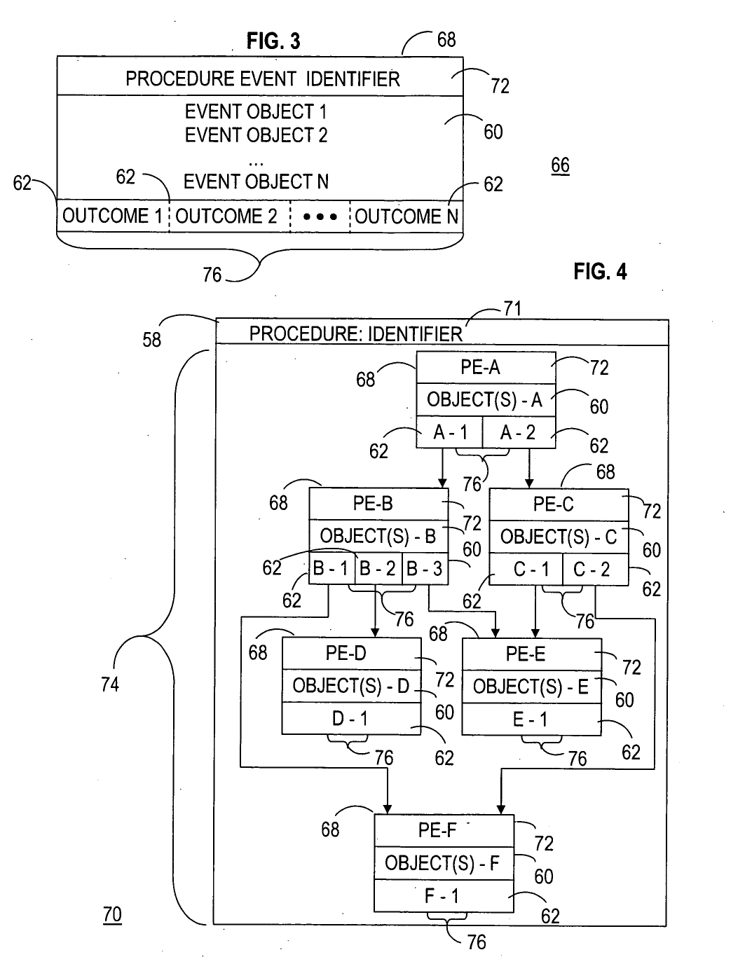

Referring to FIGS. 3-4, FIG. 3 shows a diagram 66 of exemplary notation for a procedure event 68, and FIG. 4 shows a diagram 70 of exemplary notation for one of procedures 58 of process management system 32 (FIG. 2). Process management system 32 may include a number of procedures 58 each of which represents a real world activity, i.e. the implementation of one of processes 34. Diagram 70 is discussed in general terms to demonstrate a workflow for one of processes 34. Similarly, diagram 66 is discussed in general terms to demonstrate the informational constituents of one of procedure events 68.

Procedure 58 is made up of collection of hierarchically ordered events (i.e., procedure events 68). Each of procedure events 68 represents a step or group of steps for managing one of processes 34, and each of procedures events 68 has a clearly set forth goal or endpoint that is to be met prior to advancing to another one of procedure events 68. Each procedure 58 is identified by a procedure identifier 71. Similarly, each procedure event 68 is identified by a procedure event identifier 72. A procedure event path 74 defines the way in which one of processes 34, modeled by procedure 58, is organized from beginning to conclusion. Procedure event path 74 is defined by using a database interface, i.e., data storage element 56, to link procedure events 68 together utilizing procedure event identifiers 72. Procedure event identifiers 72 for procedure 58 can be stored in data storage element 56 in such a way that their structure can be read from data storage element 56 and any linked procedure event identifiers 72 ascertained.

The informational constituents of each of procedure events 68 include procedure event identifier 72, any number of procedure event objects 60 capable of rendering data or input gather controls, and a set 76 of procedure event outcomes 62 allowing for notification that the associated procedure event 68 is complete.

In general, each distinct procedure event 68 in one of procedures 58 modeling one of processes 34 is singly displayed to user 24 (FIG. 1) on display 42 (FIG. 2) and awaits interaction. Once the required interaction is completed, user 24 can move to the next procedure event 68 along procedure event path 74 by selecting the appropriate procedure event outcome 62 from set 76. Each procedure event outcome 62 is linked to another procedure event 68 per the hierarchical order of procedure event path 74. User 24 continues in this fashion until procedure event path 74 has been exhausted and procedure 58, hence one of processes 34, comes to a completion. By using this methodology, many processes 34 can be modeled and presented to user 24 without burdening them with unnecessary information or inputs.

Review of procedure 58 reveals that at procedure event 68, identified as “PE-A”, when user 24 (FIG. 1) selects one of event outcomes 62, identified as “A-1”, in this exemplary situation, a branch of procedure event path 74 proceeds to another procedure event 68, identified as “PE-B.” If, for example, upon completion of procedure event 68, identified as “PE-B”, user 24 selects one of event outcomes 62, identified as “B-3”, a branch of procedure event path 74 proceeds to yet another procedure event 68, identified as “PE-E.” User 24 selection of one of event outcomes 62, identified as “E-1” advances procedure 58 to its conclusion. That is, this branch of procedure event path 74 has been exhausted and one of processes 34, modeled by procedure 58, reaches a completion. It can be seen in FIG. 4 that other branches within procedure event path 74 can lead to other procedure events 68 until procedure event path 74 has been exhausted indicating a conclusion of procedure 58, hence one of processes 34 modeled by procedure 58.

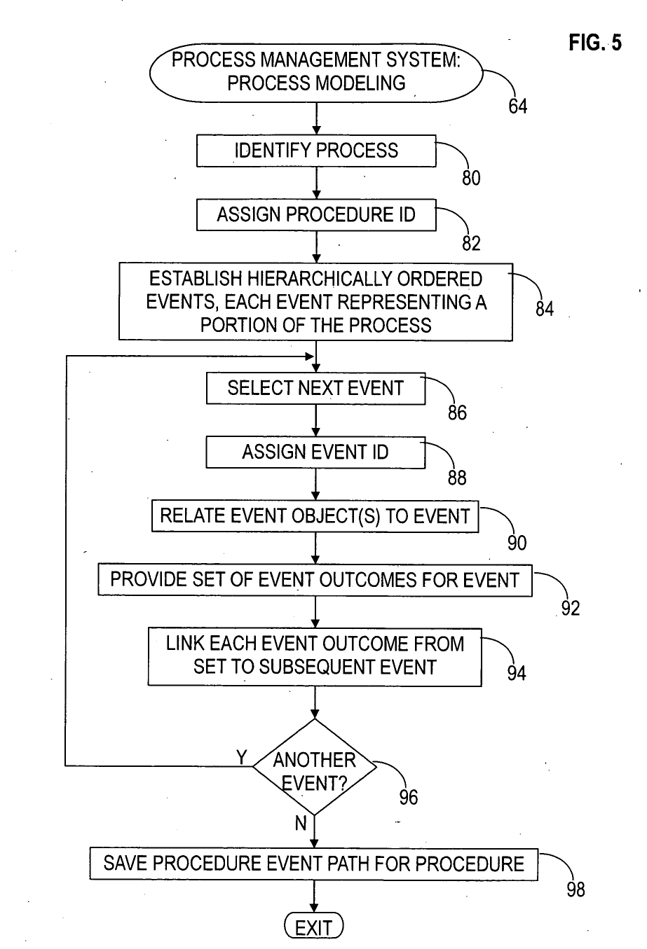

FIG. 5 shows a flowchart of process modeling component 64 of process management system 32. Process modeling component 64 is executable code that may be utilized by an outside procedure developer for an organization to generate procedures 58 (FIG. 4) modeling processes 34 pertinent to that organization. Optionally, a knowledgeable user 24 (FIG. 1) may develop their own procedures 58 using provided event objects 60 (FIG. 2) and procedure event outcomes 62 (FIG. 2).

Process modeling 64 begins with a task 80. At task 80, one of processes 34 (FIG. 2), is identified. In the scenario mentioned above, one of processes 34 may be a judicial process processed governed by Canon Law. For example, a Formal Annulment may be identified as being a judicial process to be modeled at task 80.

In response to task 80, a task 82 is performed. At task 82, one of procedure identifiers 71 (FIG. 4) is assigned for the eventual one of procedures 58.

Next, a task 84 is performed to establish hierarchically ordered procedure events 68 (FIG. 4), each one of procedure events 68 representing a portion of the one of processes 34 being modeled. In this example, hierarchically ordered procedure events 68 are crafted to follow the specific sequence of steps as laid forth for Formal Annulment by Canon Law. At this phase in the execution of process modeling component 64, procedure events 68 can be visualized as empty containers, the specific software entities, i.e., event objects 60 (FIG. 2) and procedure event outcomes 62 (FIG. 2) having not yet been defined.

Following task 84, a task 86 is performed. At task 86, the procedure developer selects a next one of procedure events 68 (FIG. 3) to be developed. It should be understood that at a first iteration of task 86, a “next” one of procedure events 68 is actually a first one of procedure events 68, and is likely to be a first procedure event 68 in procedure 58 being created.

In response to task 86, a task 88 is performed. At task 88, the procedure developer assigns one of procedure event identifiers 72 (FIG. 3) to the selected one of procedure events 68.

Next, at a task 90, the procedure developer relates one or more event objects 60 (FIG. 2) from data storage element 56 to the selected one of procedure events 68. Additionally, the procedure developer may create customized event objects 60 for storage into data storage element 56 that may also be utilized at task 90. Relating task 90 causes a future invocation of the selected one of procedure events 68 to mediate access to and the execution of the related event objects 60 from data storage element 56.

Following task 90, a task 92 is performed. At task 92, the procedure developer provides set 76 (FIG. 4) of procedure event outcomes 62. (FIG. 2) from data storage element 56 to the selected one of procedure events 68. Providing task 90 causes a future invocation of the selected one of procedure events 68 to present set 76 of procedure event outcomes 62 on display 42 (FIG. 2) with its associated one of procedure events 68.

In response to task 92, a task 94 is performed. At task 94, the procedure developer links each of event outcomes 62 from set 76 provided at task 92 to a subsequent one of procedure events 68 (FIG. 2).

Following task 94, a query task 96 determines whether there is another of procedure events 68 within the hierarchically ordered events established at task 84 to be developed. When there is another of procedure events 68, program control loops back to task 86 to repeat the above-described process for the next one of procedure events. However, when query task 96 determines that there is not another one of procedure events 68, program control proceeds to a task 98.

At task 98, procedure event path 74 (FIG. 4) summarizing and defining one of processes 34 (FIG. 2) via hierarchically ordered procedure events 68 is saved as one of procedures 58 (FIG. 2) in data storage element 56 (FIG. 2), identifiable by one of procedure identifiers 71 (FIG. 4). Following task 98, process modeling component 64 exits having generated one of procedures 58 for managing the implementation of one of processes 34. Processing modeling component 64 can be repeated any number of times for modeling any number of processes 34 pertinent to an organization.

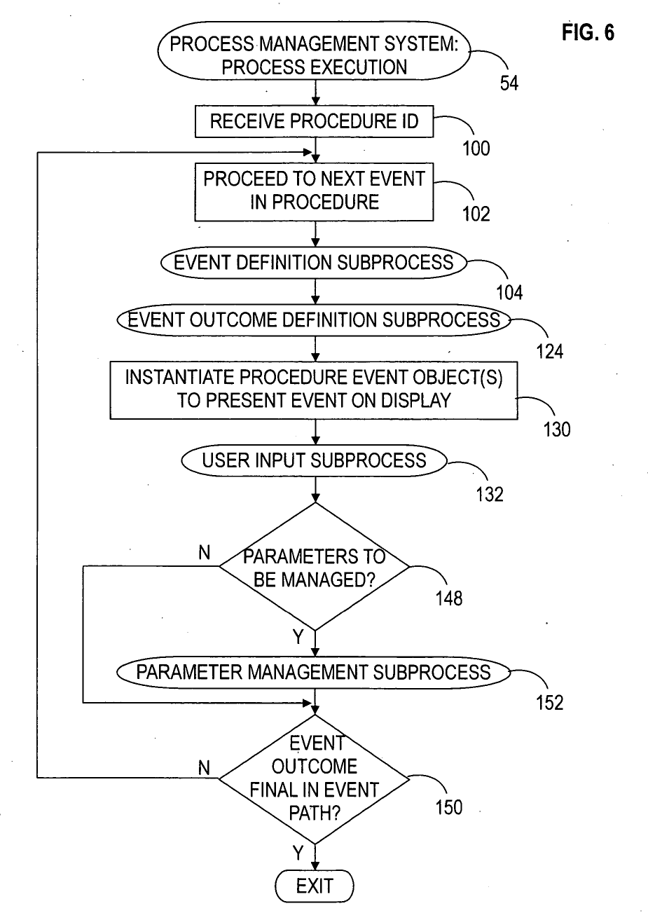

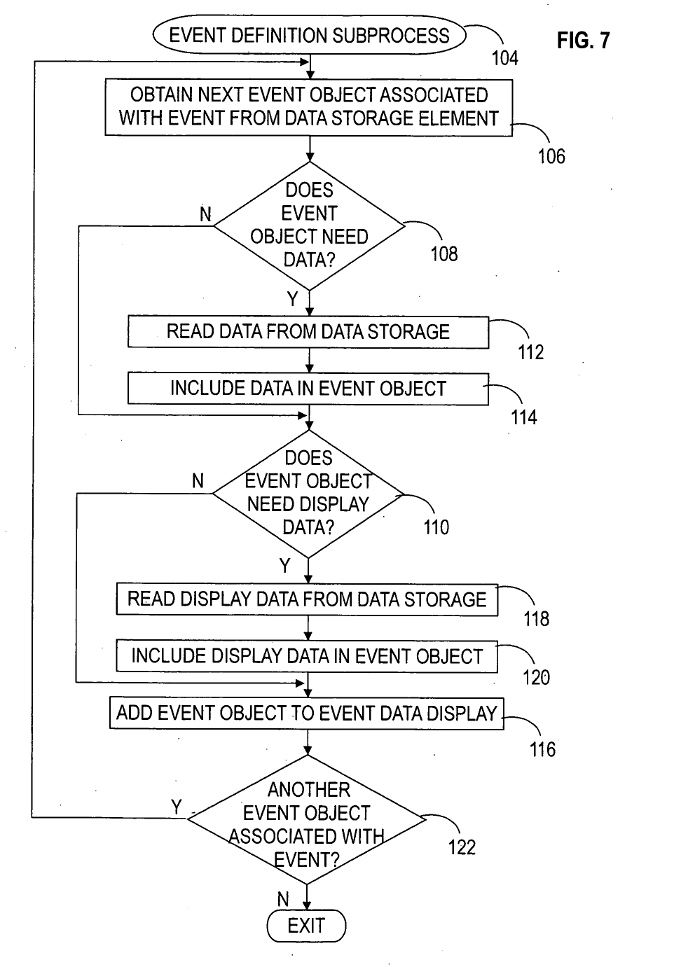

FIG. 6 shows a flowchart of a process execution component 54 of process management system 32. Process execution component 54 provides methodology for operations performed by processor 36 (FIG. 2) of computing system 30 (FIG. 2) to carry out a process instance, i.e., the management of a single one of cases 45 (FIG. 2). As discussed above, multiple instances of process execution component 54 may be running concurrently on computing system 30 (FIG. 2) in order to manage the implementation of multiple cases 45.

Process execution component 54 begins with a task 100. At task 100, computing system 30 receives procedure identifier 71 (FIG. 3) identifying one of procedures 58 (FIG. 4) to be executed. That is, user 24 selects one of procedures 58 (FIG. 4) from data storage element 56 (FIG. 2) modeling the one of processes 34 he or she wishes to implement.

A task 102 is performed following task 100. At task 102, processor 36 (FIG. 2) proceeds to a next one of procedure events 68 (FIG. 3) in the selected one of procedures 58. Of course, during a first iteration of task 102, a “next” one of procedure events 68 is a first one of procedures events 68 defined in procedure event path 74 (FIG. 4) of the selected one of procedures 58.

In response to task 102, an event definition subprocess 104 is performed. FIG. 7 shows a flowchart of event definition subprocess 104. As mentioned above, procedure events 68 mediate access to and the execution of the related event objects 60 (FIG. 2) from data storage element 56. Event definition subprocess 104 provides methodology for operations performed by processor 36 (FIG. 2) to access the related event objects 60.

Event definition subprocess 104 begins with a task 106. At task 106, processor 36 obtains the next one of event objects 60 associated with and specified within the selected one of procedure events 68 (FIG. 3). Again, during a first iteration of task 106, the “next” one of event objects 60 is a first one of event objects 60 associated with the selected one of procedure events 68.

In response to task 106, a query task 108 determines whether the one of event objects 60 obtained at task 106 needs data. This data may be data 47 previously saved in database 46 in association with one of cases 45 (FIG. 2) currently being managed. Alternatively, this data may be other data stored either in data storage element 56 or in database 46 that may be periodically updated independent from the one of cases 45 currently being managed.

When query task 108 determines that the one of event objects 60 doesn't need data, subprocess 104 proceeds to a query task 110 (discussed below). However, when query task 108 determines that data is needed by event object 60, a task 112 is performed.

At task 112, processor 36 reads data from data storage element 56 and/or database 46.

A task 114 is performed in conjunction with task 112. At task 114, processor 36 includes the data in the one of event objects 60.

Following task 114 or, alternatively, following task 108 when no data is needed, event definition subprocess 104 continues with query task 110. Query task 110 determines whether the one of event objects 60 needs display data. Display data may be code that defines default image layout within event data display 43 (FIG. 2) on display 42 (FIG. 2). When query task 110 determines that the one of event objects 60 does not need display data, subprocess 104 proceeds to a task 116 (discussed below). However, when query task 110 determines that display data is needed by event object 60, a task 118 is performed.

At task 118, processor 36 reads display data from data storage element 56. A task 120 is performed in conjunction with task 118. At task 120, processor 36 includes the display data in the one of event objects 60.

Following task 120 or, alternatively, following task 110 when no data is needed, event definition subprocess 104 continues with task 116. At task 116, the assembled one of event objects 60 is added to event data display 43 (FIG. 2).

Following task 116, event definition subprocess 104 proceeds to a query task 122. At query task 122, processor 36 determines whether another one of event objects 60 is associated with the selected one of procedure events 68 (FIG. 3). When there is another of event objects 60, subprocess 104 loops back to task 106 to repeat the execution of operations for the next one of event objects 60. However, when there is not another of event objects 60, event definition subprocess 104 exits.

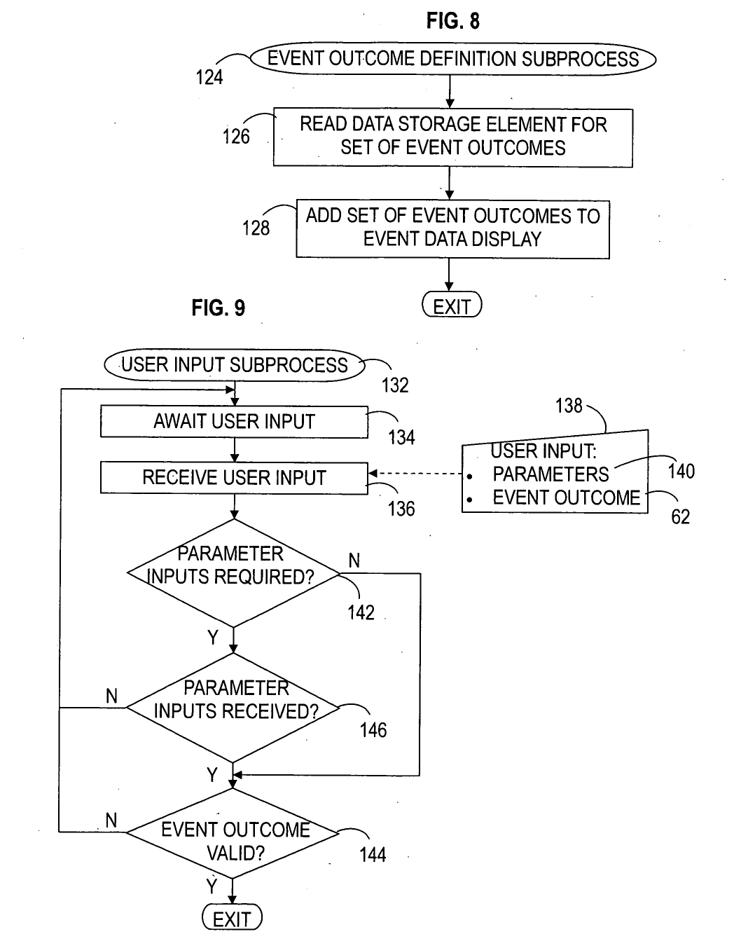

Returning to FIG. 6, when event definition subprocess 104 of process execution component 54 exits, program control proceeds to an event outcome definition subprocess 124. FIG. 8 shows a flowchart of event outcome definition subprocess 124. As mentioned above, procedure event outcomes 62 (FIG. 2) are provided within each of procedure events 68. That is, each of procedure events 68 mediates access to set 76 (FIG. 4) of event outcomes 62 from data storage element 56 (FIG. 2). Event outcome definition subprocess 124 provides methodology for operations performed by processor 36 (FIG. 2) to access set 76 of event outcomes 62.

Event outcome definition subprocess 124 begins with a task 126. At task 126, processor 36 reads set 76 of event outcomes 62 from data storage element 56. A task 128 is performed in conjunction with task 126. At task 128, processor 36 adds set 76 of event outcomes 62 to event data display 43 (FIG. 2). Following task 128, event outcome definition subprocess 124 exits.

Returning to FIG. 6, when event outcome definition subprocess 124 of process execution component 54 exits, program control proceeds to a task 130. At task 130, event objects 60 of the selected one of procedure events 68 is instantiated, i.e., rendered, to present procedure event 68 on display 42 (FIG. 2) as event data display 43 (FIG. 2).

In response to task 130, a user input subprocess 132 is performed. Referring to FIG. 9, FIG. 9 shows a flowchart of user input subprocess 130. As mentioned above, when one of procedure events 68 is presented as event data display 43 (FIG. 2), the one of cases 34 currently being managed awaits interaction by user 24 (FIG. 1) before proceeding to another one of procedure events 68. User input subprocess 132 provides methodology for operations performed by processor 36 (FIG. 2) to await and receive user input from user 24.

User input subprocess 132 begins with a task 134. At task 134, processor 36 awaits user input. The input of information by user 24 may occur after some defined or undefined duration of time. Consequently, the one of cases 34 currently being managed cannot proceed from the currently displayed one of procedure events 68 until an input of information by user 24. As such, event data display 43 will remain unchanged.

After a duration of time, a task 136 is eventually performed. At task 136, processor 36 receives user input 138. User input 138 may be in the form of parameter inputs 140 and/or a selected one of event outcomes 62 (FIG. 4). Parameter inputs 140 may be the entry of any information required within one of procedure events 68 presented as event data display 43.

In response to task 136, a query task 142 is performed. At query task 142, processor 36 determines whether parameter inputs 140 were required at the presented one of procedure events 68. When parameter inputs 140 are not required, program control proceeds to a query task 144 (discussed below). Alternatively, when parameter inputs 140 are required, program control proceeds to a query task 146.

When parameter inputs 140 are required at query task 142, query task 146 verifies that parameter inputs 140 were actually received. When the required parameter inputs 140 have not yet been received, user input subprocess 132 loops back to task 134 to await user input 138 in the form of parameter inputs 140. That is, user input subprocess 132 prevents the progression of one of cases 34 currently being managed until all required parameter inputs 140 have been entered. This safeguard is crucial to the efficient execution of subsequent procedure events 68 that are dependent upon the receipt of parameter inputs 140 obtained at an earlier one of procedure events 68. However, when query task 146 determines that the required parameter inputs 140 have been received, user input subprocess 132 proceeds to query task 144.

When parameter inputs 140 are not required at query task 142, or when verification has been ascertained that the required parameter inputs 140 have been received at query task 146, query task 144 then verifies that user input 138 included a valid one of event outcomes 62. When one of event outcomes 62 is not selected or a selected one of event outcomes 62 is in any way invalidated, user input subprocess 132 loops back to task 134 to await user input 138 in the form of one of event outcomes 62. As such, user input subprocess 132 prevents the progression of one of cases 34 currently being managed until a valid one of event outcomes 62 is selected. When verification is made at query task 144 that a valid one of procedure event outcomes 62 has been selected user input subprocess 132 exits.

Returning to FIG. 6, when user input subprocess 132 of process execution component 54 exits, program control proceeds to a query task 148. At query task 148, processor 36 determines whether parameter inputs 140 (FIG. 9) were received and require further management. When parameter inputs 140 were not required and not received per user input subprocess 132 (FIG. 9), program control proceeds to a query task 150 (discussed below). However, when parameter inputs 140 were received per user input subprocess 132, program control proceeds to a parameter management subprocess 152.

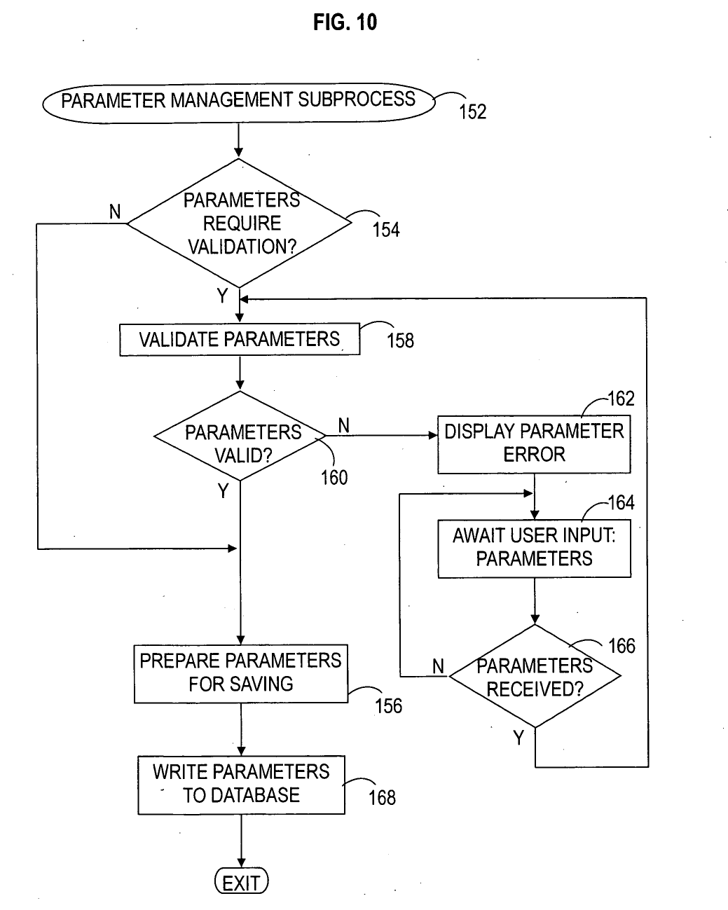

FIG. 10 shows a flowchart of parameter management subprocess 152. Parameter management subprocess 152 provides methodology for operations performed by processor 36 (FIG. 2) to validate and retain parameter inputs 140 (FIG. 9) in database 46 (FIG. 2).

Parameter management subprocess 152 begins with a query task 154. At query task 154, a determination is made as to whether parameter inputs 140 (FIG. 9) require validation. When parameter inputs 140 do not require validation, parameter management subprocess 152 proceeds to a task 156 (discussed below). However, when parameter inputs 140 require validation, subprocess 152 proceeds to a task 158.

At task 158, processor 36 validates parameter inputs 140. Validation may entail comparing parameter inputs 140 to a pre-determined list, a range of values, or any other such metric established by the procedure developer.

A query task 160 is performed in conjunction with task 158. At query task 160, a determination is made as to the validity of parameter inputs 140. When the received parameter inputs 140 (FIG. 9) are deemed valid, parameter management subprocess 152 proceeds to task 156 (discussed below). However, when the received parameter inputs 140 are invalid, program control proceeds to a task 162.

At task 162, a parameter error may be presented in conjunction with, or as an overlay to, event data display 43. A typical error display may include an error message, indicators denoting incorrect parameter inputs, and so forth known to those skilled in the art.

Following task 162, parameter management subprocess 152 proceeds to a task 164. At task 164, processor 36 awaits user input in the form of parameter inputs 140. Consequently, the one of cases 34 currently being managed cannot proceed from the currently displayed one of procedure events 68 until parameter inputs 140 (FIG. 9) are again received.

Subprocess 152 eventually proceeds to a query task 166. At query task 166, processor 36 determines whether parameter inputs 140 have again been received. As such, query task 166 can be a periodic polling activity that determines whether the management and implementation of one of cases 34 can continue. When a determination is made at query task 166 that parameter inputs 140 have not been received, subprocess 152 loops back to task 164 to await parameter inputs 140. Once parameter inputs 140 have been received, however, parameter management subprocess 152 loops back to query task 154 to establish their validity.

When query task 160 determines that parameter inputs 140 are valid, or when query task 154 determines that a validity check is not required, task 156 prepares parameter inputs 140 for saving. Preparation may entail configuring parameter inputs 140 in a format suitable as data 47 (FIG. 2) establishing status indicators 48 (FIG. 2) denoting the progression of the one of cases 34 currently being denoted, and so forth.

Following task 160, a task 168 subsequently writes parameter inputs 140 as data 47 (FIG. 2) to database 46 (FIG. 2) in association with an instance of the one of procedure events executed for the one of cases 34 currently being managed. Following task 160, parameter management subprocess 152 exits. By storing data 47 and/or status 48 in database 46 (FIG. 2) at a first instant in time, data can later be applied to a subsequent on of procedure events 68 (FIG. 3) at a second instant in time. Additionally, other authorized users 24 (FIG. 1) within network 20 (FIG. 1) at computing system 30 or other distinct computing systems 22 may be enabled to directly enter and check the status of certain cases 45, to work remotely and fulfill their duties regarding particular cases 45, to obtain documents and procedures remotely, and so forth.

Returning to FIG. 6, when parameter management subprocess 152 of process execution component 54 exits, program control proceeds to query task 150. Alternatively, when query task 148 determines that there are no parameter inputs 140 to be managed, program control proceeds to query task 150.

At query task 150, processor 36 determines whether the selected one of event outcomes 62 (FIG. 4) received as part of user input 138 (FIG. 9) is a final in procedure event path 74 (FIG. 4). When the selected one of event outcomes 62 is not final, process execution component 54 loops back to task 102 to proceed to the next one of procedure events 68 (FIG. 3) linked to the selected one of event outcomes 62. However, when the selected one of event outcomes 62 is final, process execution for a single one of cases 45 exits indicating that an instance of a particular one of processes 34 is complete.

By using the concept of a procedure modeling a process, the procedure being made up of hierarchically ordered and linked procedure events, complicated processes 34 can be broken out into procedure events 68 that users 24 (FIG. 1) with limited understanding can accomplish and move forward. The understanding of a particular one of processes 34 is simplified and allows for shorter training time and better resource utilization. This mode allows for better personnel management by streamlining the process in question and guiding users 24 through the necessary or required steps within one of processes 34 (FIG. 2) with little deviation or hesitation.

Subsequent figures provide an example of a process instance of one of processes 34. In the example, the one of processes 34 is a Formal Annulment process 34, for one of cases 45, referred to hereinafter as a first case. For brevity, only four procedure events 68 are modeled in Formal Annulment process 34.

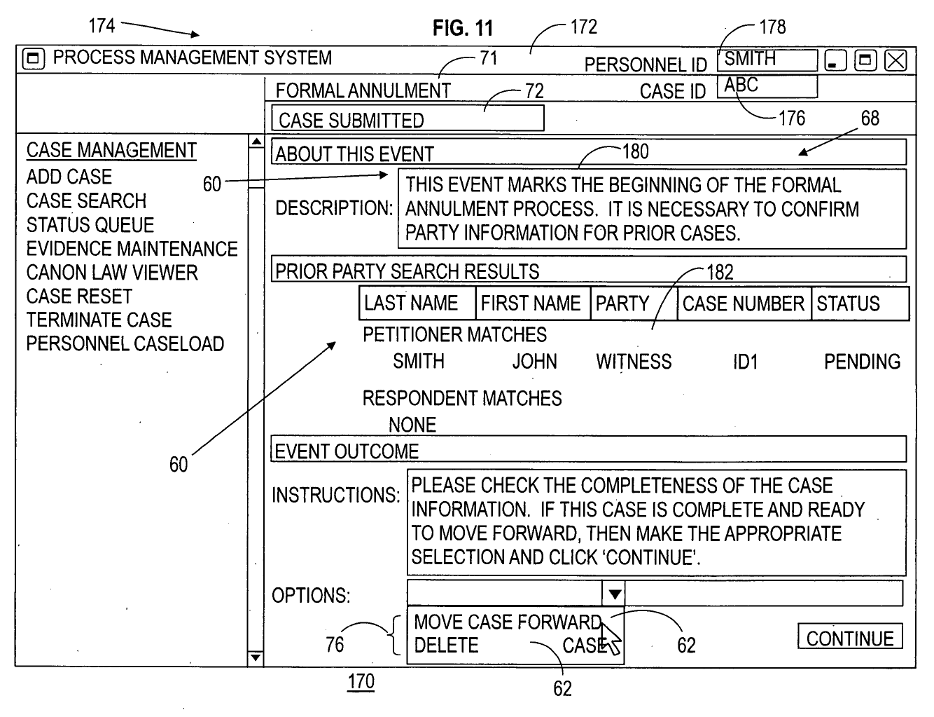

FIG. 11 shows a screen shot image 170 presented in response to execution of process execution component 54 (FIG. 6) of process management system 32 (FIG. 2). In particular, screen shot image 170 illustrates a first event data display 172 of a first procedure event 68 for a first one of cases 45, referred to herein as a first case 174. First case 174 is one instance of an entire one of processes 34 (FIG. 2).

First case 174 is identified by a case identifier 176. A personnel identifier 178 may optionally be included to identify the staff member currently working with first case 174. Procedure identifier 71 identifies the particular process being implemented for first case 174 as a “Formal Annulment” process 34.

First case 174 begins when a “Petitioner” files for a marriage annulment. Procedure event identifier 72 identifies a first one of procedure events 68 being performed as a “Case Submitted.” First event data display 172 includes the rendering of two event objects 60. One of event objects 60 provides an event description 180, and a second one of event objects 62 calls for the entry of petitioner information 182. Set 76 of event outcomes 62 includes two event outcomes 62, “move case forward” and “delete case.”

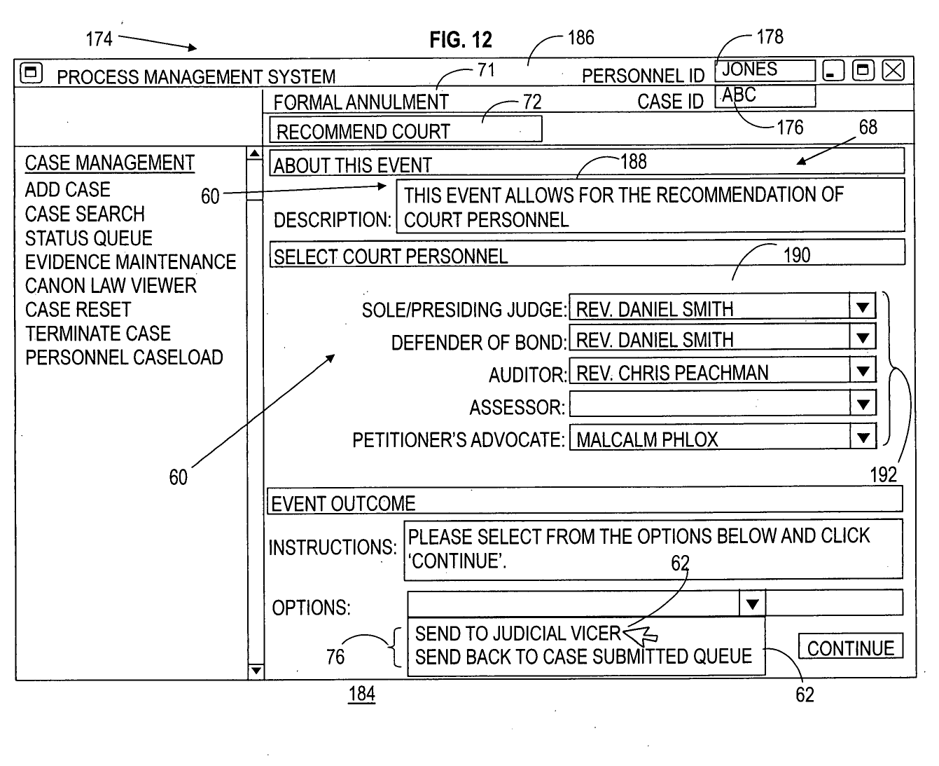

FIG. 12 shows a screen shot image 184 illustrating a second event data display 186 of a second one of procedure events 68 for first case 174. This procedure event 68 is instantiated, or rendered, when “move case forward” event outcome 62 was selected from first event data display 172 (FIG. 11). Procedure event identifier 72 identifies this second one of procedure events 68 being performed as “Recommend Court.”

Second event data display 186 again includes the rendering of two event objects 60. One of event objects 60 provides an event description 188, and a second one of event objects 62 calls for the selection of court personnel 190. In this scenario, the selection of court personnel 190 is facilitated through the use of dropdown select boxes 192 for user selection. Dropdown select boxes 192 were defined and rendered as part of this procedure event 68. Set 76 of event outcomes 62 includes two event outcomes 62, “send to judicial vicar” and “send back to case submitted queue.”

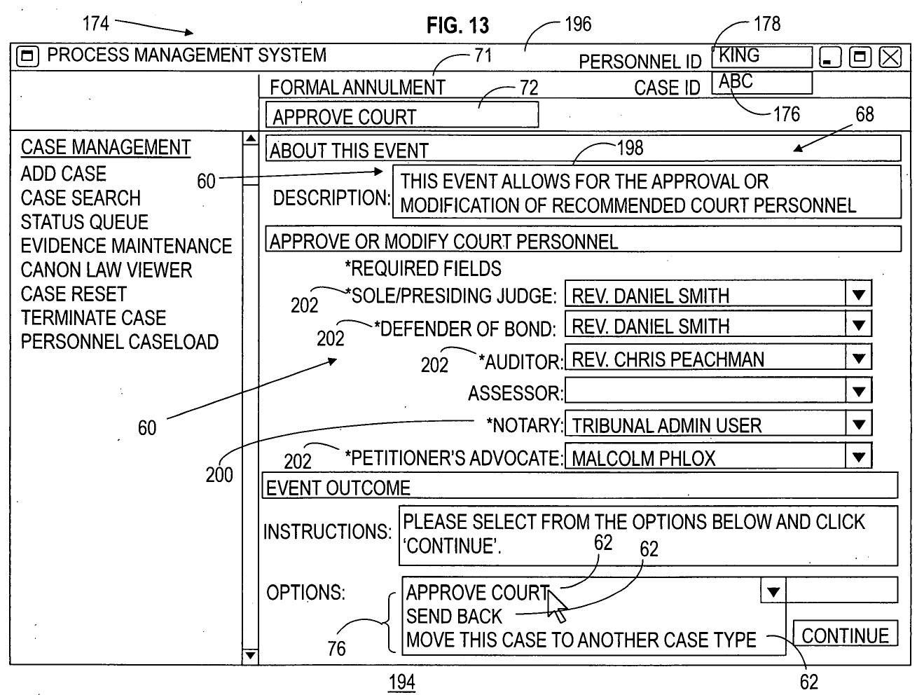

FIG. 13 shows a screen shot image 194 illustrating a third event data display 196 of a third one of procedure events 68 for first case 174. This procedure event 68 is instantiated, or rendered, when “send to judicial vicar” event outcome 62 was selected from second event data display 186 (FIG. 12). Procedure event identifier 72 identifies this third one of procedure events 68 being performed as “Approve Court.”

Third event data display 196 includes the rendering of two event objects 60. One of event objects 60 provides an event description 198. A second one of event objects 60, although similar in appearance to that shown in second event data display 186 (FIG. 12), includes the addition of a notary field 200 and the addition of required fields 202. Set 76 of event outcomes 62 includes three event outcomes 62, “approve court,” “send back,” and “move this case to another case type.”

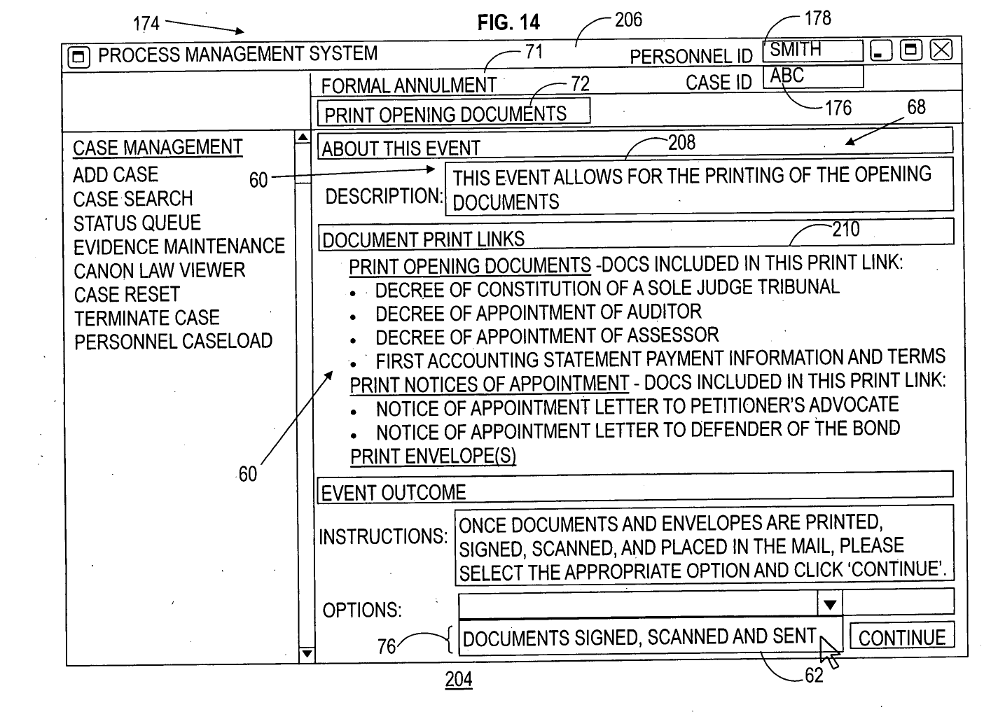

FIG. 14 shows a screen shot image 204 illustrating a fourth event data display 206 of a fourth one of procedure events 68 for first case 174. This procedure event 68 is instantiated, or rendered, when “approve court” event outcome 62 was selected from third event data display 196 (FIG. 13). Procedure event identifier 72 identifies this third one of procedure events 68 being performed as “Print Opening Documents.”

Fourth event data display 206 includes the rendering of two event objects 60. One of event objects 60 provides an event description 208. A second one of event objects 60 includes print links 210 for opening documents, print notices of appointment, and envelopes. The documents and envelopes may be automatically generated in response to the information input during previous procedure events 68, as shown above. As such, user 24 (FIG. 1) need not manually create the documents, thereby utilizing personnel time more efficiently and concurrently reducing the potential for error. Set 76 of event outcomes 62 includes a single one of event outcomes 62, “documents signed, scanned, and sent.”

Procedure 58 for first case 174 can thus continue with subsequent event data displays 43 (FIG. 2) for each subsequent one of procedure events 68 (FIG. 3) until procedure event path 74 (FIG. 4) has been exhausted and first case 174 comes to a completion.

In summary, the present invention teaches of a computer-based method and a computer program for managing implementation of a process. Through the implementation of a procedure event path of hierarchically ordered events, the computer-based method and a computer program promote an orderly and controlled passage of tasks within a process. This methodology results in a computer-based process that can be presented to a user in stepwise fashion without burdening them with unnecessary information or inputs, thereby allowing for effective utilization of resources. The object-oriented configuration enables cost effective implementation and modification of the process management system. Moreover, the present invention creates a sharing and more-communicative environment utilizing computer-based technology, and provides the ability to process a high volume of information and paper in an efficient and more productive manner.

Although the preferred embodiments of the invention have been illustrated and described in detail, it will be readily apparent to those skilled in the art that various modifications may be made therein without departing from the spirit of the invention or from the scope of the appended claims. For example, the process steps discussed herein can take on great number of variations and can be performed in a differing order then that which was presented.

What is claimed is:

1. A method utilizing a computing system for managing implementation of a process comprising:
enabling selection of a procedure from a data storage element of said computing system, said procedure including hierarchically ordered events, each of said events representing a portion of said process, said each event having a set of event outcomes associated therewith, each of said event outcomes of said set being linked to another of said events within said procedure;
obtaining, from said data storage element, an event object associated with a first one of said events;
instantiating said event object to present said first event and said set of event outcomes associated with said first event to a user;
receiving at said computing system a user input that includes one of said event outcomes from said set of event outcomes, said one event outcome indicating a completion of said first event; and
proceeding to said another of said events within said procedure to implement said process in response to said one event outcome.

2. A method as claimed in claim 1 wherein:
said event object is a first event object;
said obtaining operation obtains a second event object associated with said first event from said data storage element; and
said instantiating operation instantiates said second event object in conjunction with said first event object.

3. A method as claimed in claim 1 further comprising:
determining that said event object calls for an input of data;
reading said data from said data storage element; and
including said data in said event object for presentation within said first event.

4. A method as claimed in claim 1 further comprising enabling said user to interact with said presented first event prior to receipt of said user input of said one event outcome.

5. A method as claimed in claim 1 further comprising:
enabling said user to enter parameters in connection with said presented first event; and
retaining said parameters in a database in association with an instance of said first event.

6. A method as claimed in claim 5 further comprising applying said parameters retained in said database to said another of said events.

7. A method as claimed in claim 5 wherein said retaining operation occurs at a first instant, and said method further comprises accessing said parameters at a second instant, said second instant occurring after said first instant.

8. A method as claimed in claim 7 wherein said computing system is a first computing system, and said accessing operation is performed at a second computing system distinct from said first computing system.

9. A method as claimed in claim 1 further comprising preventing said proceeding operation until said one event outcome is received.

10. A method as claimed in claim 1 wherein said process is a first instance of said process, and said method further comprises performing said enabling, obtaining, instantiating, receiving, and proceeding operations for a second instance of said process.

11. A method as claimed in claim 1 wherein prior to said enabling operation, said method further comprises defining said procedure that models said process.

12. A method as claimed in claim 11 wherein said defining operation comprising:
establishing said hierarchically ordered events:
providing said set of event outcomes for said each of said events;
for said each of said events, linking said each event outcome of said set to said another of said events to define a procedure event path; and
saving said procedure event path for said procedure in said data storage element.

13. A method as claimed in claim 12 wherein said defining operation further comprises assigning a distinct event identifier to said each of said events, said linking operation utilizing said distinct event identifier to link said each event outcome to said another of said events.

14. A method as claimed in claim 12 wherein said event object is one of a plurality of event objects in said data storage element, and said defining operation further comprises relating at least one of said plurality of event objects to said each of said events.

15. A computer-readable storage medium for managing implementation of a process comprising:
a data storage element having a procedure and a plurality of event objects stored therein, said procedure including hierarchically ordered events, each of said events representing a portion of said process, said each event having a set of event outcomes associated therewith, each of said event outcomes of said set being linked to another of said events within said procedure; and
executable code for instructing a processor to perform operations comprising:
enabling selection of said procedure from said data storage element;
obtaining, from said data storage element, a first one of said plurality of event objects associated with a first one of said events;
instantiating said first event object to present said first event and said set of event outcomes associated with said first event to a user;
enabling said user to interact with said presented first event;
receiving at said computing system following said enabling operation a user input that includes one of said event outcomes from said set of event outcomes, said one event outcome indicating a completion of said first event; and
proceeding to said another of said events within said procedure to implement said process in response to said one event outcome, said proceeding operation being prevented until said one event outcome is received.

16. A computer-readable storage medium as claimed in claim 15 wherein said executable code instructs said processor to perform further operations comprising:
obtaining, from said data storage element, a second one of said plurality of event objects associated with said first event; and
instantiating said second event object in conjunction with said first event object.

17. A computer-readable storage medium as claimed in claim 15 wherein said executable code instructs said processor to perform further operations comprising:
determining that said first event object calls for an input of data;
reading said data from said data storage element; and
including said data in said first event object for presentation within said first event.

18. A computer-readable storage medium as claimed in claim 15 wherein said executable code instructs said processor to perform further operations of said enabling operation comprising:
receiving parameters from said user in connection with said presented first event; and
retaining said parameters in a database in association with an instance of said first event.

19. A computer-readable storage medium as claimed in claim 18 wherein said executable code instructs said processor to perform a further operation comprising applying said parameters retained in said database to said another of said events.

20. A computer-readable storage medium as claimed in claim 19 wherein said processor is a first processor, said retaining operation occurs at a first instant, and said executable code instructs a second processor to perform further operations comprising:
accessing said parameters at a second instant, said second instant occurring after said first instant; and
performing said applying operation.

21. A computer program product for managing implementation of a process comprising:
a data storage element containing a plurality of event objects;
a process modeling component for instructing a processor to define a procedure that models said process, said process modeling component instructing said processor to perform operations comprising:
establishing hierarchically ordered events, each of said events representing a portion of said process;
relating at least one of said event objects from said plurality of event objects to said each of said events;
providing a set of event outcomes from said data storage element for said each of said events;
for said each of said events, linking one of said event outcomes from said set to another of said events to define a procedure event path for said procedure; and
saving said procedure event path for said procedure in said data storage element; and
a process execution component for instructing said processor to perform operations comprising:
enabling selection of said procedure from said data storage element;
obtaining, from said data storage element, said at least one event object associated with a first one of said events;
instantiating said at least one event object to present said first event and said set of event outcomes associated with said first event to a user;
receiving a user input that includes one of said event outcomes from said set of event outcomes, said one event outcome indicating a completion of said first event; and
proceeding to said another of said events within said procedure to implement said process in response to said one event outcome.

22. A computer program product as claimed in claim 21 wherein said process is a first instance of said process, and said method further comprises performing said enabling, obtaining, instantiating, receiving, and proceeding operations for a second instance of said process.
